(19) United States
(12) Patent Application Publication
(10) Pub. No.: US 2024/0069961 A1
(43) Pub. Date: Feb. 29, 2024

(54) BATCH FUNCTIONS FRAMEWORK

(71) Applicant: American Express Travel Related Services Company, Inc., New York, NY (US)

(72) Inventors: Edward K. SAMSON, Phoenix, AZ (US); Anuj GOYAL, Phoenix, AZ (US); Michael D. WIRSIG, Phoenix, AZ (US); Brandon Michael Thomas Bradley, Phoenix, AZ (US)

(73) Assignee: American Express Travel Related Services Company, Inc., New York, NY (US)

(21) Appl. No.: 17/893,518

(22) Filed: Aug. 23, 2022

(51) Int. Cl. G06F 9/48; G06F 9/50

(52) U.S. Cl. CPC G06F 9/4881; G06F 9/5077; G06F 2209/505

(57) ABSTRACT

Disclosed herein are system, method, and computer program product embodiments for individually deploying batch functions in a cluster computing environment. A batch function system may receive a scheduled batch job for execution at a particular timing. Rather than deploying the corresponding batch functions as a bundled monolith, the batch function system may individually deploy corresponding batch functions. To individually deploy the batch functions, the batch function system may use a verticle data structure for defining a batch job. The batch function system may then execute a batch function corresponding to the batch job on a cluster computing platform by deploying the batch function to a pod executing on computing nodes. Upon individual completion of execution, the batch function system may release the pod and/or computing nodes to make the computing resources available. The batch function system may also preserve and pass data between pods executing batch functions.

### BACKGROUND

### Field

This field is generally related to a batch processing system configured to execute batch functions.

### Related Art

Computerized batch processing refers to a process of automatically running software programs to perform high volume data management or tasks. Users submit tasks as jobs, which are automatically executed in batches. Batches may be automatically run at scheduled times as well as being run contingent on the availability of computer resources. An example of a batch job may be, for example, a program that reads a large file or database of information and generates a report.

In traditional batch processing applications, batch jobs are organized into bundles for execution. For example, in the context of a cluster computing platform or cloud computing, batch jobs are bundled into an archive and deployed as a monolith or in bundled packages. Further, in a cloud computing context employing multiple computing nodes, when a particular node begins to process a bundle of jobs, the process must execute on the same node from start to finish. This results in the inefficient restriction of computing resources as well as computing delays waiting for the execution of a complete bundle of batch jobs.

Similarly, because of the bundling, the execution of codes or batch jobs is not modular. Additionally, the computer resources costs increase linearly with code modularity. As a result, this configuration is heavy and not portable. Further, regarding portability, deploying localized instances of functions within different computing environments is not possible. Traditionally, bundled batch jobs must execute on proprietary environments, which also limits flexibility and deployment of functions in different computing environments.

Further, these configurations focus on real-time execution and employ limit limits for executing batch jobs. For example, responses are expected within a specific time, such as within 15 minutes or 100 seconds. This time limit restricts flexible function execution and also limits portability to execute in different computing environments and contexts.

### BRIEF SUMMARY

Disclosed herein are system, apparatus, device, method and/or computer program product embodiments, and/or combinations and sub-combinations thereof, for a batch function system that individually deploys batch functions.

A batch job may include one or more batch functions. A batch job may be a program scheduled to execute during non-working hours such as in the evening or the weekend when a computing system may be idle. In some embodiments, a batch job may be an automated task scheduled to run regularly or periodically. For example, a batch job for an enterprise system may be to read customer transactions records from a database and to generate a monthly bill document file for each customer account. Such a batch job may be automated and/or scheduled for execution. Other batch jobs may include, for example, inventory processing, data conversion, report generation, a payroll process, image processing, printing, warehouse management, and/or other scheduled or automated computing tasks. While some batch jobs may be executed periodically, batch jobs may also be defined to be executed a limited number of times, such as once, twice, or a particular number of instances.

As further explained below, a batch job may include one or more batch functions, which may be executed to perform the batch job. The batch function system uses a batch function framework to build batch jobs and to individually deploy their corresponding batch functions independently and in a modular manner. The batch function framework also uses asynchronous events, which may avoid restrictive time limits for execution. In this manner, long-running batch functions may also be deployed. The batch function system may also be deployed in a cloud computing environment and/or using a cluster or computing nodes. As will be further explained below, the architecture of the batch function framework also provides portability. For example, the batch function framework allows for deployment on a Kubernetes cluster and/or a Kubernetes environment. The batch function framework may provide isolation and/or individual deployment when deploying batch functions in the Kubernetes environment. This provides flexibility in the computing environment where the batch function framework may be deployed.

The batch function framework's individual deployment of batch functions also provides support for building modular functions. For example, traditional systems may schedule the execution of batch jobs using a batch controller. This batch controller bundles the batch jobs into an archive and then deploys the archives to a cloud environment for execution. This may occur, for example, in both Function-as-a-Service and Platform-as-a-service cloud environments. This type of deployment, however, is not modular and therefore results in linearly increasing computing costs with code modularity. This additionally becomes problematic because when a particular cloud computing node begins an execution process, the process must run on the same node from start to finish. To address this issue, the batch function framework individually deploys batch functions. In this manner, when a particular batch function completes execution, the resources assign for executing that particular batch function are released. Those resources may then be used to execute other functions. In this manner, the batch function framework provides a modular environment to build and execute batch functions.

The batch function framework additionally provides a horizontally scalable in-memory database and/or in-memory data grid. This in-memory data grid stores and/or caches frequently used lookup data to increase the speed of batch function execution. This lookup data may include data that is shared and/or utilized by different batch functions that are executed. This provides additional computational efficiency over existing bundled execution systems. Additionally, the batch function framework provides an event bus that is shared among clusters of pods to distribute a batch job across one or more pods. This may provide load balancing of batch processing between pods. A pod may be an instance of a running process in a cluster. Pods may run on one or more computing nodes of a cluster. Nodes may be virtual or physical machines. In some embodiments, the one or more pods may be Kubernetes pods. The batch function framework may utilize pods operating on nodes in a cluster to individually and/or independently execute batch functions.

To implement the batch function framework, a batch function system may include a client interface, a cluster system, and/or a deployment database. As discussed further below, the client interface may interface with a client system to receive a batch job and/or a timing for executing the batch job. For example, the client interface may receive one or more batch job configurations from a client system via graphical user interface (GUI) or via an application programming interface (API). The cluster system may then individually deploy batch functions corresponding to the one or more batch jobs. The cluster system may use one or more pods executing on computing nodes in a cluster to execute the one or more batch functions. The one or more pods may share a clustered event bus for load balancing. The one or more pods may also share data using an in-memory data grid (IMDG). The cluster system may also manage parallel processing of each batch function among the pods. This may aid with faster execution.

In addition to managing the deployment of batch functions, the cluster system may also monitor when a batch function completes execution. When a batch function completes execution, the cluster system releases or un-deploys the batch function from the one or more pods or cluster nodes used to execute the batch function. This process allows those computing resources to be re-used. This also avoids the inefficiencies resulting from bundled batch jobs. In addition to managing pods and/or nodes in this manner, the cluster system may also use a deployment database to track the execution batch functions. For example, the deployment database may include schedules, job logs, data regarding nodes executing a particular job, and/or deployment details including a deployment identification. The deployment identification may also be used when releasing nodes from completed batch functions.

The cluster system may also use the in-memory data grid to maintain data shared between runs or executions of batch functions. For example, the deployment database may be an in-memory data grid accessed by the pods and/or nodes to access data or properties used to execute a particular batch function. Properties may refer to data used, consumed, and/or generated when executing a particular batch function. These properties may have been provided with a current batch function and/or retrieved based on storage from a previous batch function execution. When a particular batch function finishes execution, one or more properties may be preserved to be used in a subsequent execution of a batch function. These batch functions may be the same or may be different.

The cluster system may also preserve and/or manage properties across batch functions that may be executing in parallel. The cluster system may manage property data to avoid race conditions. This may be a scenario where a particular batch function must use property data from the execution of another batch function. For example, a first batch function may rely on a property generated from the execution of a second batch function. When both the first and second batch functions are executing in parallel, the cluster system may ensure that the property generated by the second batch function is available to the first batch function for execution.

### BRIEF DESCRIPTION OF THE DRAWINGS

The accompanying drawings are incorporated herein and form a part of the specification.

FIG. 1 depicts a block diagram of an example batch function execution environment, according to some embodiments.

FIG. 2 depicts a block diagram of an example batch function framework executed by a batch function system, according to some embodiments.

FIG. 3 depicts a flowchart illustrating a method for individually executing batch functions, according to some embodiments.

FIG. 4 depicts a flowchart illustrating a method for deploying a batch function, according to some embodiments.

FIG. 5 depicts a flowchart illustrating a method for executing a deployed batch function, according to some embodiments.

FIG. 6 depicts a flowchart illustrating a method for post-processing a batch function, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for individually executing batch functions. Various embodiments of these features will now be discussed with respect to the corresponding figures.

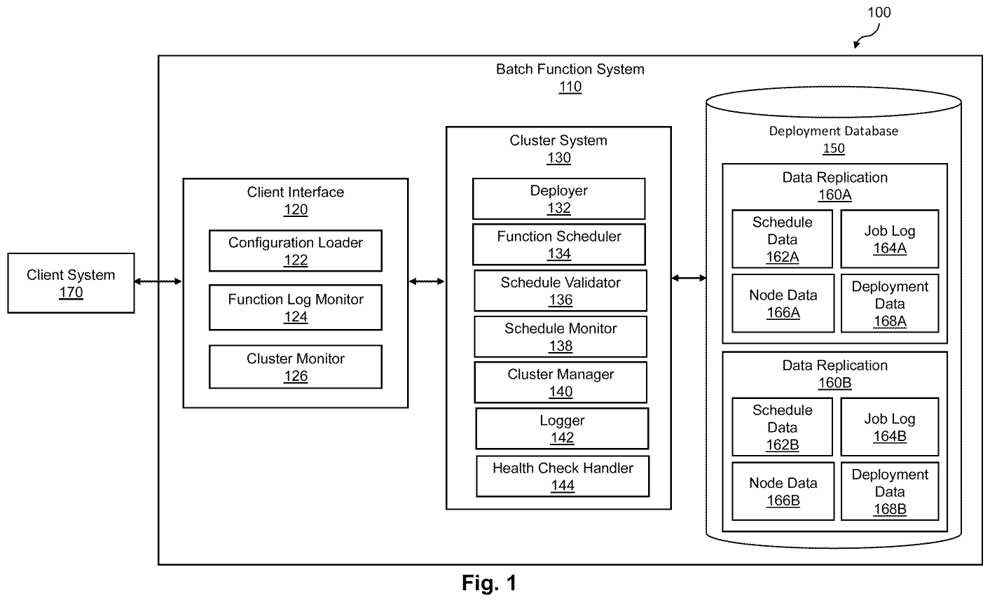

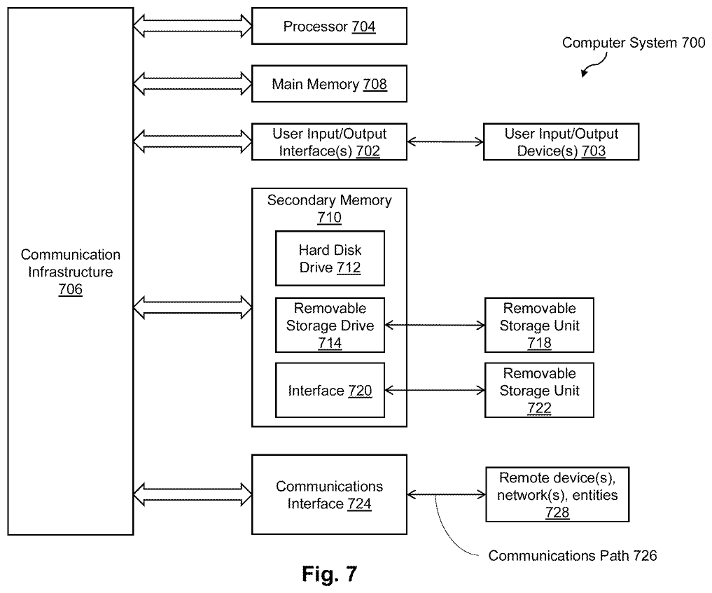

FIG. 1 depicts a block diagram of a batch function execution environment 100, according to some embodiments. Batch function execution environment 100 may include a batch function system 110 and a client system 170. Batch function system 110 may include a client interface 120, cluster system 130, and/or deployment database 150. Batch function system 110 may operate on one or more servers and/or databases. In some embodiments, batch function system 110 may be implemented using computer system 700 as described further with reference to FIG. 7. Batch function system 110 may provide a cluster computing platform or a cloud computing platform to execute functions designated by client system 170.

Client system 170 may be a user device accessing batch function system 110 via the Internet, wireless protocol, wired protocol and/or other communication interface. In some embodiments, batch function system 110 may be an enterprise computing system. Client system 170 may be a workstation and/or user device used to access, communicate with, and/or manipulate the enterprise computing system. Batch function system 110 may include client interface 120 to facilitate these communications with client system 170.

Batch function system 110 may receive one or more batch job designations from client system 170. While one client system 170 is depicted, batch function system 110 may also interface with multiple client systems 170 to receive batch job. Client system 170 may access batch function system 110 using a graphical user interface (GUI) provided by batch function system 110 and/or via an application programing interface (API) provided by batch function system 110. Configuration loader 122 may be configured to allow one or both of these options to receive the batch job designations from client system 170.

In the GUI case, batch function system 110 may provide an application, such as a web application, to client system 170 to render a GUI. By interacting with the GUI using client system 170, a user may define parameters for a batch job. For example, a user may identify one or more batch functions for execution. The user may also define a timing for executing the one or more batch functions. This timing may specify a particular time, whether the batch job is to be executed periodically, and/or a number of instances the batch job should be executed. For example, a user may define a batch job that is to be executed at a particular time. Some examples may include “7 PM everyday,” “5 PM on Fridays,” “the last day of each month,” or “at 4 PM each day from Monday through Friday.” The user may provide textual input, coding input, and/or use one or more fillable forms, drop-down menus, icons, selections, and/or other GUI objects to provide the timing and/or to configure the batch job. Batch function system 110 may then convert this designation to a schedule data structure as further explained below.

Using configuration loader 122, client system 170 may also provide the batch job configuration using an API. The API may be a REST API. The API may be used to define a schedule data structure. This schedule data structure may be used by batch function system 110 to individually execute the corresponding batch functions. For example, the schedule data structure may use a Vert.x configuration to provide deployment of individual batch functions. The schedule data structure may include verticles to encapsulate functional units for processing. A verticle may be an event-driven code component that receives events and/or produces responses. For example, an event may be an HTTP request or a trigger of a timer. A response may be an HTTP response or a console output. A verticle may provide a repository interface on a database and/or issue a request to a third-party system. In some embodiments, a verticle may be a single-threaded code component and/or may be non-blocking. Verticles may be used in an event-driven application and/or may refer to portions of codes deployed by a Vert.x engine. The verticle may encapsulate a technical functional unit for processing events. By formatting a batch function using a verticle, batch function system 110 may individually deploy batch functions in cluster system 130.

Returning to the receipt of a batch job configuration, whether received via API or GUI, batch function system 110 may format the batch job into a schedule data structure. For example, the schedule data structure may be formatted in a JSON format. The schedule data structure may include a job schedule, a list of verticles to deploy for the batch job, a triggering event once deployment completes, a timeout for a batch job, an identification of one or more verticle properties to use during deployment, and/or an identification of one or more properties to be sent from one execution to another. Using one or more of these parameters, batch function system 110 may organize batch functions for individual execution.

In addition to receiving scheduling for batch functions, client interface 120 may also allow client system 170 to provide additional data for batch functions. For example, batch function system 110 may receive, set, and/or update global properties for batch functions and/or properties specific to particular executions.

Client system 170 may also obtain and/or modify information corresponding to scheduled batch jobs and/or functions. For example, configuration loader 122 may obtain the one or more scheduled batch jobs, delete one or more scheduled batch jobs, update schedule information, update batch job parameters, validate schedule information, and/or enable or disable a scheduled batch job. Function log monitor 124 may also monitor logs of batch jobs and/or corresponding execution status. For example, function log monitor 124 may identify one or more instances of a batch job completing execution. Function log monitor 124 may also obtain data corresponding to parameters and/or configurations used to execute a particular batch job and/or outputs that are produced from the execution of a batch job. Function log monitor 124 may provide this information to client system 170 for viewing.

Client system 170 may also use cluster monitor 126 to view cluster health information and/or monitor batch jobs currently executing. Regarding the cluster health information, this may include identifying one or more cluster nodes that are still intact. Regarding the batch jobs currently executing, this may include identifying the number of jobs and/or particular job that are actively executing. This may provide real-time data to client system 170 to monitor batch job execution activity.

Having received a batch job configuration from client system 170, batch function system 110 may execute the batch job and/or one or more corresponding batch functions using cluster system 130 and/or deployment database 150. Cluster system 130 may include one or more components used to deploy and/or execute batch jobs and/or batch functions on one or more pods executing on one or more clustered computing nodes. For example, cluster system 130 may include deployer 132. Deployer 132 may deploy a particular batch job for execution on a pod according to the scheduled timing. In some embodiments, deployer 132 may implement Vert.x processing. Deployer 132 may deploy a batch job according to the one or more verticles and/or properties defined in the corresponding schedule data structure.

Cluster system 130 may also include function scheduler 134. Function scheduler 134 may store batch job and/or batch function schedule information into deployment database 150. Deployment database 150 may be an in-memory data grid which may be accessed by the pods and/or computing nodes. For example, schedule monitor 138 may access stored schedule information when monitoring schedules. Based on this data, schedule monitor 138 may trigger deployer 132 to deploy a scheduled batch job and/or batch function for execution. Cluster system 130 may also include schedule validator 136, which may validate the schedules. This validation may occur, for example, when client system 170 provides a configuration for a batch job. In some embodiments, schedule validator 136 may confirm that cluster system 130 is capable of executing the scheduled batch job and/or that the scheduling would not cause errors.

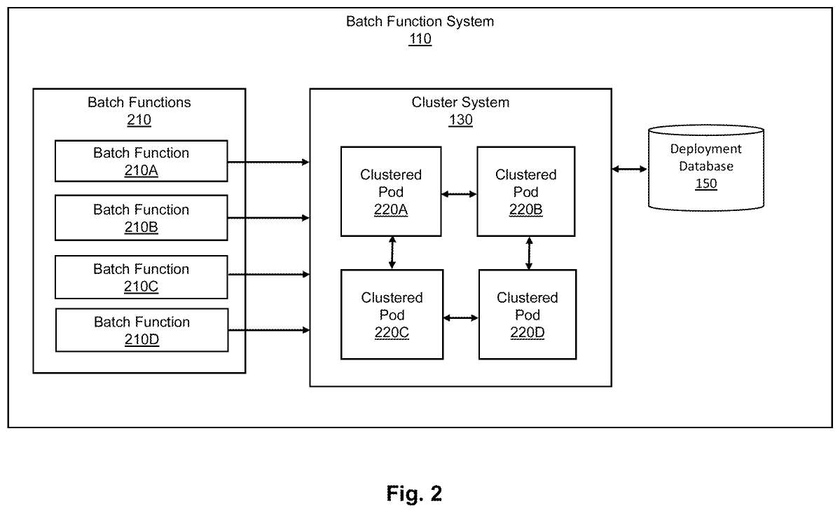

Cluster system 130 may also include cluster manager 140, logger 142, and/or health check handler 144. Cluster manager 140 may establish the one or more clustered pods executing on computing nodes to execute the one or more batch functions. The execution of batch functions via the clustered pods will be discussed further below with reference to FIG. 2. To execute one or more batch functions, cluster manager 140 may ensure that cluster pods are established and/or that there are a minimum number of pods configured for the cluster. In some embodiments, this threshold may be determined by the number of scheduled and/or executing batch functions. Cluster manager 140 may dynamically generate and/or release cluster pods to manage the workload of the scheduled batch functions. In some embodiments, cluster manager 140 may manage a Hazelcast cluster. This may allow for deployment of batch functions on a Kubernetes cluster in a cloud environment. Logger 142 may log output data from the pods. For example, this may be logged in deployment database 150. Health check handler 144 may monitor the health of the batch jobs that are currently executing. For example, the health data may include the current state of execution of a batch job. In some embodiments, health check handler 144 may generate an alert transmitted to client system 144 if or when a particular batch job fails execution.

Batch function system 110 may also include deployment database 150. Deployment database 150 may be an in-memory data grid (IMDG). Deployment database 150 may manage data shared across pods when executing one or more batch functions. In some embodiments, deployment database 150 may implement a Hazelcast based IMDG. Deployment database 150 may include one or more data replications 160. These may provide redundancies and/or may represent one or more pods accessing data when executing a batch function. Data replications 160 may represent persistent data that may remain independent from data used to execute a particular batch function. For example, this data may include schedule data 162, job log 164, node data 166, and/or deployment data 168.

Schedule data 162 may be an in-memory data object that stores information about batch function schedules. This data may represented stored schedules corresponding to one or more executing batch functions. Job log 164 may store information related to a start time, end time, and/or properties used to execute batch jobs. Similar to schedule data 162, job log 164 provides details for executing a batch job. Node data 166 may record information identifying the nodes used to execute a particular batch job. For example, when a batch job utilizes multiple computing nodes, node data 166 may preserve this data. Deployment data 168 may include deployment details. For example, deployer 132 may generate a deployment identification, which may be later used to release or un-deploy a batch function from a pod when a batch function has completed execution. Deployer 132 may log the deployment identification and/or other deployment information as deployment data 168 when deploying a particular batch function.

In some embodiments, the data preserved in deployment database 150 may be accessible to client system 170 via client interface 120. As previously explained, client interface 120 may provide client system 120 with status information related to batch functions that have completed execution and/or are currently executing. A user viewing this information via client system 170 may then determine whether the execution is occurring as expected. The user may also be able to use this information to alter the parameters of a particular batch job and/or the scheduling for a batch job.

FIG. 2 depicts a block diagram of an example batch function framework executed by batch function system 110, according to some embodiments. Batch function system 110 operate in the manner described with reference to FIG. 1. For example, batch function system 110 may include cluster system 130 and/or deployment database 150. As seen from FIG. 2, cluster system 130 may receive one or more batch functions 210. Cluster system 130 may then execute the batch functions 210 using clustered pods 220. As previously explained, batch function system may operate in a cloud computing environment when providing the framework for executing batch functions 210.

As previously explained, cluster system 130 may use clustered pods 220 to execute the batch functions 210. A clustered pod 220 may represent an instance of a running process used to execute a batch function 210. A clustered pod 220 may be a group of one or more containers and/or may share storage and network resources with a specification for how to execute the containers. A clustered pod 220 may run on a computing node of a cluster. The computing node may be a virtual or physical machine, depending on the cluster. In some embodiments, clustered pods 220 may be Kubernetes pods operating in a Kubernetes cluster and/or a Kubernetes environment.

In some embodiments, clustered pods 220 may be created as replicas to execute a batch function. Cluster system 130 may manage the lifecycle of the clustered pods 220 and/or may also perform horizontal scaling to modify the number of clustered pods 220. For example, cluster system 130 may generate and/or release clustered pods 220 to execute batch functions 210. To generate a clustered pod 220, cluster system 130 may initialize clustered pod 220 on a computing node in a cluster and/or create the containers of the clustered pod 220. Cluster system 130 may be aware of the CPU and/or memory resources of a node and may avoid scheduling a clustered pod 220 onto a node that does not have resources available to execute the clustered pod 220. After binding clustered pod 220 to a node and the containers have been created, clustered pod 220 may execute the batch function 210 using at least one of the containers. The execution of the clustered pod 220 may return success when the containers have terminated successfully. In some instances, a clustered pod 220 may terminate in failure. In this case, cluster system 130 may attempt to execute the batch function 210 using another clustered pod 220.

Clustered pods 220 may use an in-memory data grid (IMDG) to share information. For example, as previously explained, deployment database 150 may be an IMDG. This architecture may support high scalability, parallel execution, and data distribution in a clustered environment. For example, the IMDG may store and cache frequently used data. The IMDG may also be used to pass information between clustered pods 220 for executing batch functions 210. In some embodiments, cluster system 130 may use a Hazelcast IMDG to facilitate shared data between clustered pods 220. Clustered pods 220 may also share an event bus to distribute batch jobs across clustered pods 220. This may aid with load balancing events.

As previously explained, clustered pods 220 may execute batch functions 210 according to their corresponding timing and/or schedule. For example, cluster system 130 may deploy batch functions to clustered pods 220 for execution based on this timing. As further explained below, cluster system 130 may execute a verticle data structure with corresponding function properties when a batch function is scheduled to execute. While deploying a batch function, cluster system 130 may monitor execution in the manner described with reference to FIG. 1. In some embodiments, cluster system 130 may also distribute data and/or properties generated by a particular clustered pod 220 to another clustered pod 220. This may also be done in a manner that avoids race conditions. After a batch function has been executed, cluster system 130 also releases or un-deploys the batch function from the clustered pod 220. Cluster system 130 may also clean the run data to reset the computing environment. For example, cluster system 130 may remove a deployment identification from deployment database 150 to indicate that a clustered pod 220 has completed execution of the batch function.

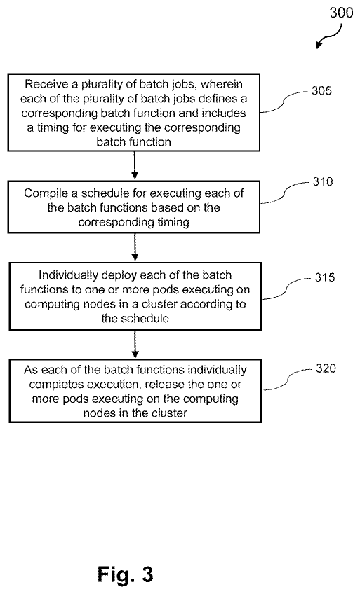

The process of deployment, execution, and release or un-deployment is further described with reference to FIGS. 3-6.

FIG. 3 depicts a flowchart illustrating a method 300 for individually executing batch functions, according to some embodiments. Method 300 shall be described with reference to FIGS. 1 and 2; however, method 300 is not limited to that example embodiment.

In an embodiment, batch function system 110 may utilize method 300 to execute one or more batch functions 210. Method 300 may individually deploy batch functions 210 to clustered pods 220 for execution. The foregoing description will describe an embodiment of the execution of method 300 with respect to batch function system 110. While method 300 is described with reference to batch function system 110, method 300 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, batch function system 110 may receive a plurality of batch jobs, wherein each of the plurality of batch jobs defines a corresponding batch function 210 and includes a timing for executing the corresponding batch function 210. As previously explained, batch function system 110 may provide a client interface 120 to communicate with client system 170 to receive a batch job configuration. For example, client system 170 may use a GUI and/or an API to provide a batch job configuration. This configuration may include a timing. The timing may identify a periodicity for executing the batch job and/or a number of instances to execute the batch job. In some embodiments, client system 170 may also define a project to provide the batch jobs. The project may include the creation of a cluster service and/or fork data from an online repository for deployment on a clustered pods 220. In some embodiments, source code and/or dependencies may be retrieved from GitHub to define the plurality of batch jobs.

As previously explained, the received configuration may be received in and/or converted to a schedule data structure. This schedule data structure may allow for individually deployment of the batch functions 210. The schedule data structure may include one or more verticles to encapsulate functional units for processing. Verticles may refer to portions of codes deployed by a Vert.x engine. By formatting a batch function using a verticle, batch function system 110 may individually deploy batch functions 210 in cluster system 130. The schedule data structure may include a job schedule, a list of verticles to deploy for the batch job, a triggering event once deployment completes, a timeout for a batch job, an identification of one or more verticle properties to use during deployment, and/or an identification of one or more properties to be sent from one execution to another.

At 310, batch function system 110 may compile a schedule for executing each of the batch functions 210 based on the corresponding timing. Batch function system 110 may store this schedule information in deployment database 150. Batch function system 110 may deploy each of the batch functions 210 according to the schedule.

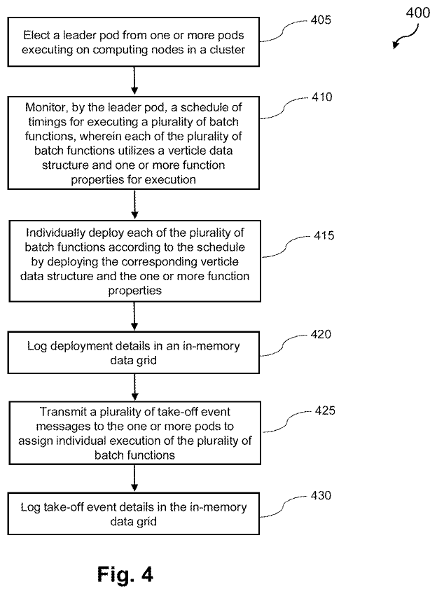

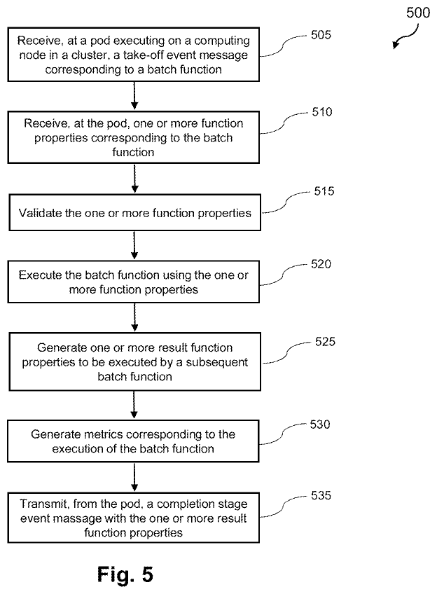

At 315, batch function system 110 may individually deploy each of the batch functions 210 to one or more pods executing on computing nodes in a cluster according to the schedule. The pods may be clustered pods 220. As further explained with reference to FIG. 4, this deployment may be based on the scheduled data structure described above. The individual deployment of the batch functions 210 may allow for individual execution and completion, which provides more efficient computing usage relative to a configuration that bundles batch jobs for execution as a monolith. As further described with reference to FIG. 5, a clustered pod 220 may execute a batch function 210 and/or generate one or more function properties and/or metrics related to execution. In this manner, batch function system 110 may monitor execution status and/or provide this information to client system 170.

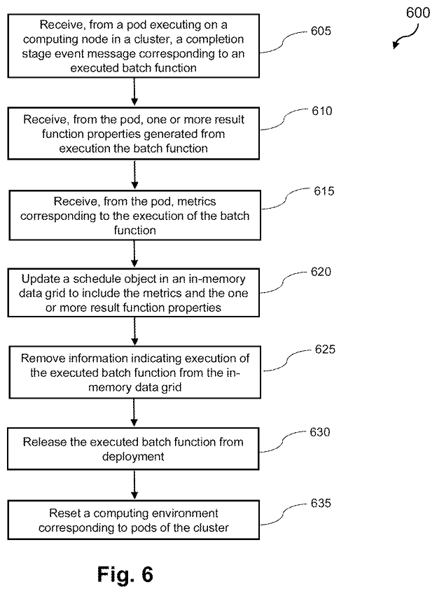

At 320, as each of the batch functions 210 individually completes execution, batch function system 110 may release the one or more pods executing on the computing nodes in the cluster. This may complete the individual execution of the batch functions and/or may free computing resources for other tasks. As will be further explained with reference to FIG. 6, batch function system 110 may log the completion of execution and/or may store data or function properties that may be used by other and/or future executions of batch functions 210.

FIG. 4 depicts a flowchart illustrating a method 400 for deploying a batch function, according to some embodiments. Method 400 shall be described with reference to FIGS. 1 and 2; however, method 400 is not limited to that example embodiment.

In an embodiment, batch function system 110 may utilize method 400 to deploy one or more batch functions 210. Method 400 may individually deploy batch functions 210 to clustered pods 220 for execution. The foregoing description will describe an embodiment of the execution of method 400 with respect to batch function system 110. While method 400 is described with reference to batch function system 110, method 400 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 405, batch function system 110 may elect a leader pod from one or more pods executing on computing nodes in a cluster. The one or more pods may be clustered pods 220. In some embodiments, the leader pod may operate to perform the schedule monitoring process described with reference to cluster system 130. In some embodiments, the election may be via a Kubernetes election process.

At 410, batch function system 110 may monitor, using the leader pod, a schedule of timings for executing a plurality of batch functions 210, wherein each of the plurality of batch functions 210 utilizes a verticle data structure and one or more function properties for execution. This schedule may have been received from client system 170 and/or stored in deployment database 150. The verticle data structure may include the timing information. The verticle data structure may include a job schedule, a list of verticles to deploy for the batch job, a triggering event once deployment completes, a timeout for a batch job, an identification of one or more verticle properties to use during deployment, and/or an identification of one or more properties to be sent from one execution to another. Using one or more of these parameters, batch function system 110 may organize batch functions for individual execution. In some embodiments, the function properties may be identified by the verticle data structure. The function properties may include properties specific to a particular batch job or batch function, global properties, and/or properties generated from previous executions of batch functions. In some embodiments, the verticle data structure may also define properties that will be generated from the execution of the corresponding batch function 210. These properties may be utilized in later executions of batch functions 210. In some embodiments, the schedule data structure may be formatted in a JSON format.

At 415, batch function system 110 may individually deploy each of the plurality of batch functions 210 according to the schedule by deploying the corresponding verticle data structure and the one or more function properties. For example, cluster system 130 may transmit a deploy event for the scheduled batch function 210. One or more deployers 132 may identify the deployed event and identify a clustered pod 220 for executing a batch function 210. The deployer 132 may identify multiple clustered pods 220 to execute the plurality of batch functions 210 individually. When deploying a particular batch function 210, deployer 132 may deploy the verticle data structure as well as one or more function properties to be used during execution.

At 420, batch function system 110 may log deployment details in an in-memory data grid (IMDG). In some embodiments, the IMDG may be deployment database 150. The logged deployment details may include deployment data 168. Deployment data 168 may include a deployment identification, which may be later used to release or un-deploy a batch function from a pod when a batch function has completed execution. Deployer 132 may log the deployment identification and/or other deployment information as deployment data 168 when deploying a particular batch function 210. This allows for tracking and/or monitoring as previously described.

At 425, batch function system 110 may transmit a plurality of take-off event messages to the one or more pods to assign individual execution of the plurality of batch functions 210. A clustered pod 220 may consume a take-off event message to initiate the execution of the batch function 210. As will be further described with reference to FIG. 5, the clustered pod 220 may also utilize one or more function properties that may be provided with the take-off event message. The one or more function properties may include properties specific to the particular run or execution of the batch function, global function properties, and/or function properties preserved from a previous run or execution. Batch function system 110 may provide these function properties to the clustered pods 220 at 425.

At 430, batch function system 110 may log take-off event details in the in-memory data grid. For example, batch function system 110 may update job log 164, node data 166, and/or deployment data 168 stored in deployment database 150. This may track the particular pods and/or computing nodes that are executing batch functions 210. The logging of this data may provide execution status for client system 170. Batch function system 110 may also use this information when releasing or un-deploying a pod and/or cluster when a batch function has completed execution. This is described in more detail with reference to FIG. 6.

FIG. 5 depicts a flowchart illustrating a method 500 for executing a deployed batch function, according to some embodiments. Method 500 shall be described with reference to FIGS. 1 and 2; however, method 500 is not limited to that example embodiment.

In an embodiment, batch function system 110 may utilize method 500 to execute one or more batch functions 210 at a clustered pod 220. Method 500 may be executed by clustered pod 220 once the batch function 210 has been deployed. The foregoing description will describe an embodiment of the execution of method 500 with respect to batch function system 110. While method 500 is described with reference to batch function system 110, method 500 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 505, a clustered pod 220 executing on a computing node in a cluster may receive a take-off event message corresponding to a batch function 210. As explained with reference to FIG. 4, the take-off event message may be generated by batch function system 110 when deploying a batch function 210. The clustered pod 220 assign to execute the batch function 210 may consume the take-off event message when executing the batch function 210.

At 510, the clustered pod 220 may receive one or more function properties corresponding to batch function 210. Clustered pod 220 may receive the one or more function properties before, together with, and/or after receiving the take-off event message at 505. As previously explained, the one or more function properties may include properties specific to the particular run or execution of the batch function, global function properties, and/or function properties preserved from a previous run or execution. In some embodiments, the one or more function properties may be Vert.x properties used during deployment. The one or more function properties may be data used, consumed, and/or generated when executing a batch function 210.

At 515, the clustered pod 220 may validate the one or more function properties. This may confirm that no errors occur when using the one or more function properties to execute the batch function 210. In some embodiments, a function property may include a configuration object for function setup and/or vault properties. Vault properties may refer to secret data and/or sensitive data that may be encrypted. In some embodiments, vault properties may be passed to clustered pod 220 to perform execute a batch function 210 applied to encrypted data and/or may allow clustered pod 220 to decrypt data to apply batch function 210. The validation at 515 may include using the vault properties to validate data used for executing batch function 210. In some embodiments, the clustered pod 220 may also transmit an acknowledgement message to cluster system 130 acknowledge that the take-off event message has been consumed.

At 520, the clustered pod 220 may execute the batch function 210 using the one or more function properties. The clustered pod 220 may process the batch function 210 according to the scheduled data structure. For example, using the one or more function properties, the clustered pod may perform the instructions specified. As previously explained, these instructions may have been provided in a Vert.x verticle format. The scheduled data structure also provides individual execution of the batch function 210.

At 525, the clustered pod 220 may generate one or more result function properties to be executed by a subsequent batch function 210. For example, the scheduled data structure may also identify data that is generated as a result of executing a particular batch function 210A. The generated result function properties may be used by another batch function 210B and/or by another instance of executing batch function 210A. In this manner, the result function properties may be passed to other executions by cluster system 130. The result function properties may be logged as well. For example, the result function property may be an updated timestamp indicating that execution has occurred.

At 530, the clustered pod 220 may generate metrics corresponding to the execution of the batch function 210. These metrics may include statistics related to processing the batch function 210. For example, clustered pod 220 may identify the number of records processed during the execution of the batch function 210. As further explained with reference to FIG. 6, cluster system 130 may store the metrics on deployment database 150. Client system 170 may access and/or view these metrics to monitor the execution of the batch function 210.

At 535, the clustered pod 220 may transmit a completion stage event message with the one or more result function properties. This completion stage event message signal to cluster system 130 that the batch function 210 has completed execution and/or that one or more result function properties may be preserved and/or passed to other batch function 210 executions. This process will be further described with reference to FIG. 6. Using the completion stage event message, cluster system 130 may un-deploy the batch function and release the clustered pod 220 and/or the computing nodes.

FIG. 6 depicts a flowchart illustrating a method 600 for post-processing a batch function, according to some embodiments. Method 600 shall be described with reference to FIGS. 1 and 2; however, method 600 is not limited to that example embodiment.

In an embodiment, batch function system 110 may utilize method 600 when a batch function 210 has completed execution. Method 600 include post-execution processes performed by cluster system 130 to preserve function properties and/or metrics as well as resetting the computing environment. In some embodiments, cluster system 130 may not receive and/or preserve any function properties or metrics. The foregoing description will describe an embodiment of the execution of method 600 with respect to batch function system 110. While method 400 is described with reference to batch function system 110, method 600 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 605, batch function system 110 may receive, from a clustered pod 220 executing on a computing node in a cluster, a completion stage event message corresponding to an executed batch function. The completion stage event message may be the one generated at 535 with reference to FIG. 5.

At 610, batch function system 110 may receive, from the clustered pod 220, one or more result function properties generated from execution of the batch function 210. As previously explained with reference to 525 and FIG. 5, these one or more result function properties may be data generated as a result of execution the batch function 210. Batch function system 110 may preserve this data in an IMDG and/or pass the data between different executions of batch functions 210. For example, other batch functions 210 may rely on this data for execution.

At 615, batch function system 110 may receive, from the clustered pod 220, metrics corresponding to the execution of the batch function. These metrics may be the metrics generated at 530 and described with reference to FIG. 5.

At 620, batch function system 110 may update a schedule object in an in-memory data grid (IMDG) to include the metrics and/or the one or more result function properties. As previously explained, the IMDG may be deployment database 150. The schedule object may be schedule data 162 and/or job log 164. For example, this may be a schedule log. Regarding the metrics, batch function system 110 may store the metrics in deployment database 150. Batch function system 110 may then provide the metrics to client system 170 for viewing and analysis. Regarding the result function properties, these may be properties used during the execution of other batch functions. For example, the result function properties may be used by batch functions 210 that are to be executed in the future and/or by batch functions 210 currently executing. Batch function system 110 storing the one or more result function properties in the IMDG may operate to preserve and/or pass the result function properties to pods executing other batch functions 210. Batch function system 110 may manage the execution and/or passing of properties to avoid race conditions as previously described.

At 625, batch function system 110 may remove information indicating execution of the executed batch function 210 from the IMDG. For example, batch function system 110 may remove node data 166 and/or deployment data 168 from the IMDG. This removal may indicate that the execution of the particular batch function 210 has been completed. Previously, batch function system 110 may have stored node data 166 and/or deployment data 168 to signify that a particular node is occupied with executing a particular batch function 210. Removing this data may indicate that the execution has completed. In some embodiments, this operation may be considered a clean up of the current run.

At 630, batch function system 110 may release the executed batch function 210 from deployment. For example, batch function system 110 may un-deploy the batch function 210. This may include releasing the clustered pod 220 and/or computing nodes. At 635, batch function system 110 may reset a computing environment corresponding to the clustered pods 220 of the cluster. For example, this may include returning the cloud computing environment to a previous state. This may allow for the execution of additional batch functions 210 and/or other functionality to execute on the computing nodes.

FIG. 7 depicts an example computer system 700 useful for implementing various embodiments. Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving a plurality of batch jobs, wherein each of the plurality of batch jobs defines a corresponding batch function for execution on a cluster computing platform and wherein each of the plurality of batch jobs includes a timing for executing the corresponding batch function;
compiling a schedule for executing each of the batch functions based on the corresponding timing;
individually deploying each of the batch functions to one or more pods executing on computing nodes in the cluster computing platform according to the schedule; and
as each of the batch functions individually completes execution, releasing the one or more pods executing on the computing nodes in the cluster.

2. The computer implemented method of claim 1, wherein receiving the plurality of batch jobs further comprises:
receiving a verticle data structure defining each of the plurality of batch jobs, wherein the verticle data structure includes the timing.

3. The computer implemented method of claim 1, further comprising:
storing result data generated from execution of a first batch function in an in-memory data grid.

4. The computer implemented method of claim 3, further comprising:
identifying a second batch function configured to use the result data when executed;
retrieving the result data from the in-memory data grid; and
passing the result data to pod configured to execute the second batch function.

5. The computer implemented method of claim 4, wherein the pod configured to execute the second batch function is configured to operate in parallel with a pod executing the first batch function.

6. The computer implemented method of claim 1, further comprising:
storing, in an in-memory data grid, a deployment identification corresponding to a computing node executing a batch function; and
deleting, from the in-memory data grid, the deployment identification in response to the batch function completing execution.

7. The computer implemented method of claim 1, further comprising:
generating a graphical user interface to display metrics corresponding to batch function execution.

8. A system, comprising:
a memory; and
at least one processor coupled to the memory and configured to:
receive a plurality of batch jobs, wherein each of the plurality of batch jobs defines a corresponding batch function for execution on a cluster computing platform and wherein each of the plurality of batch jobs includes a timing for executing the corresponding batch function;
compile a schedule for executing each of the batch functions based on the corresponding timing;
individually deploy each of the batch functions to one or more pods executing on computing nodes in the cluster computing platform according to the schedule; and
as each of the batch functions individually completes execution, release the one or more pods executing on the computing nodes in the cluster.

9. The system of claim 8, wherein to receive the plurality of batch jobs, the at least one processor is further configured to:
receive a verticle data structure defining each of the plurality of batch jobs, wherein the verticle data structure includes the timing.

10. The system of claim 8, wherein the at least one processor is further configured to:
store result data generated from execution of a first batch function in an in-memory data grid in the memory.

11. The system of claim 10, wherein the at least one processor is further configured to:
identify a second batch function configured to use the result data when executed;
retrieve the result data from the in-memory data grid; and
pass the result data to pod configured to execute the second batch function.

12. The system of claim 11, wherein the pod configured to execute the second batch function is configured to operate in parallel with a pod executing the first batch function.

13. The system of claim 8, wherein the at least one processor is further configured to:
store, in an in-memory data grid, a deployment identification corresponding to a computing node executing a batch function; and
delete, from the in-memory data grid, the deployment identification in response to the batch function completing execution.

14. The system of claim 8, wherein the at least one processor is further configured to:
generate a graphical user interface to display metrics corresponding to batch function execution.

15. A non-transitory computer-readable device having instructions stored thereon that, when executed by at least one computing device, cause the at least one computing device to perform operations comprising:
receiving a plurality of batch jobs, wherein each of the plurality of batch jobs defines a corresponding batch function for execution on a cluster computing platform and wherein each of the plurality of batch jobs includes a timing for executing the corresponding batch function;
compiling a schedule for executing each of the batch functions based on the corresponding timing;
individually deploying each of the batch functions to one or more pods executing on computing nodes in the cluster computing platform according to the schedule; and
as each of the batch functions individually completes execution, releasing the one or more pods executing on the computing nodes in the cluster.

16. The non-transitory computer-readable device of claim 15, wherein receiving the plurality of batch jobs further comprises:
receiving a verticle data structure defining each of the plurality of batch jobs, wherein the verticle data structure includes the timing.

17. The non-transitory computer-readable device of claim 15, the operations further comprising:
storing result data generated from execution of a first batch function in an in-memory data grid.

18. The non-transitory computer-readable device of claim 17, the operations further comprising:
identifying a second batch function configured to use the result data when executed;
retrieving the result data from the in-memory data grid; and
passing the result data to pod configured to execute the second batch function.

19. The non-transitory computer-readable device of claim 18, wherein the pod configured to execute the second batch function is configured to operate in parallel with a pod executing the first batch function.

20. The non-transitory computer-readable device of claim 15, the operations further comprising:
generating a graphical user interface to display metrics corresponding to batch function execution.
